(19) United States
(12) Patent Application Publication
(10) Pub. No.: US 2010/0059027 A1
(43) Pub. Date: Mar. 11, 2010

(54) METHOD TO OPTIMIZE COMBUSTION OF LIQUID FUELS

(76) Inventor: JAIRO EDUARDO LEAL JIMENEZ, Bogota (CO)

Correspondence Address: JOHN J. MARTINEZ MD. JD., 10 PALMER AVENUE, CROTON ON HUDSON, NY, 10520, US

(21) Appl. No.: 12/210,003

(22) Filed: Sep. 12, 2008

(30) Foreign Application Priority Data
Sep. 9, 2008 (CO) 08-094861

(51) Int. Cl. F02M 29/00

(52) U.S. Cl. 123/590; 239/5; 239/8

(57) ABSTRACT

The invention of the present application provides a method and a device to optimize the combustion of a liquid fuel by means of gasification of said fuel. Gasification of liquid fuel through the method and the device of the present invention is achieved by atomizing liquid fuel that is converted in very fine liquid particles, and wherein the atomization of said very fine liquid particles is done in a closed camera of an adequate volume, and wherein in said closed camera a vacuum has been generated, and wherein in said closed camera there is an adequate flow, and wherein the adequate flow is achieved by means of a flow control mechanism, and wherein the very fine liquid particles, due to the effect of the vacuum, to the proper environment generated by the existence of an adequate volume of the camera, and the adequate flow, are gasified without need of increasing temperature, nor using any mechanical mean inside the camera.

### FIELD OF THE INVENTION

The present invention provides a method and a device which purpose is the conversion of liquid fuels to a gaseous state, resulting in more complete combustion with optimal energy efficiency.

### BACKGROUND OF THE INVENTION

Gasification of liquid fuel to obtain better combustion has been described previously. However, previous descriptions show devices made under the premise that a high superficial tension in small liquid particles makes harder to gasify said particles, and therefore higher temperatures or lower pressures should be used to obtain gasification of said particles. Under the same premise a method has been described in which liquid particles have been broken by complex mechanical means.

By way of example, devices and methods with the mentioned limitations have been described in U.S. Pat. No. 4,083,340 by Furr, U.S. Pat. No. 4,515,134 by Warren, and U.S. Pat. No. 6,257,212 by Hammond.

The invention of the present application presents a method and a device to gasify liquid fuels that do not require increasing temperature, nor mechanical means to break liquid particles.

The present invention is base on additional considerations ignored in the prior art, wherein an analysis of said additional considerations allows introducing new technical aspects.

### SUMMARY OF THE INVENTION

The invention of the present application provides a method and a device to optimize the combustion of a liquid fuel by means of gasification of said fuel. Gasification of liquid fuel through the method and the device of the present invention is achieved by atomizing liquid fuel that is converted in very fine liquid particles, and wherein the atomization of said very fine liquid particles is done in a closed camera of an adequate volume, and wherein in said closed camera a vacuum has been generated, and wherein in said closed camera there is an adequate flow, and wherein the adequate flow is achieved by means of a flow control mechanism, and wherein the very fine liquid particles, due to the effect of the vacuum, to the proper environment generated by the existence of an adequate volume of the camera, and the adequate flow, are gasified without need of increasing temperature, nor using any mechanical mean inside the camera.

In addition, to the gasification, the combustion of fuel is increased by exposing said gasified fuel to ultraviolet light inside the camera.

The conception of the present invention is based on the belief that the boiling point of a fine liquid particle is not determined by superficial tension. The inventor of the present application believes that the boiling point of a fine liquid particle depends on the internal vaporization pressure of the liquid particle, wherein the internal vaporization pressure is directly proportional to the liquid particle mass, wherein the fine particle is smaller and therefore with less mass, the vaporization internal pressure is less. It is well known in the art of the invention that the boiling point of a liquid particle at low temperatures can be reached by means of diminishing the external pressure exerted over the liquid particle by the environment that surrounds the liquid particle; in other words, if there is enough vacuum in the environment that surrounds the liquid particle. However, although an adequate vacuum can exist to reach the boiling point of a liquid particle, the liquid particle is not vaporized if there is no adequate volume and an adequate flow so the liquid particle can physically expand as a gas. By its inherent condition of less density with respect to a liquid, a gas of a specific substance occupies more volume than the liquid of the same substance.

More specifically, the present invention provides a method to gasify liquid fuel wherein said method is characterized by:
A. Creating a vacuum inside a closed camera;
B. Injecting to the inside of said camera a liquid fuel through an entry line that ends with an atomizer;
C. Illuminating the inside of said camera with ultraviolet light;
D. Allowing through an exit line a gasified fuel flow toward the exterior of the camera;
E. Regulating the gasified fuel flow that goes through the exit line toward the exterior of the closed camera by means of a flow control mechanism.

In one aspect of the method of the present invention, the flow control mechanism is a flow control lineal valve.

In another aspect of the method of the present invention, the camera is illuminated with a LED (light emitting diode) that emits ultraviolet light.

In another aspect of the method of the present invention, the vacuum inside the camera is created through an additional line, wherein said additional line has a first end connected to the camera, and wherein the additional line has a second end connected to a vacuum source.

In one more aspect of the method of the present invention, the camera has an ultrasonic transducer, wherein said ultrasonic transducer breaks the molecular links that allow a liquid state.

In another aspect of the method of the present invention, the closed camera has a volume of a least 40 cubic centimeters.

The present invention also provides a device to optimize combustion of fuel that is characterized by:
A. A first camera that contains an elastic mechanism, and an exit that goes to an intake manifold, and wherein the first camera is physically united to the camera describe in B., and wherein the union between the first camera and the camera described in B. is by means of a diaphragm;
B. A second camera with an entry of a liquid fuel line, wherein at the entry of the fuel line there is an atomizer, wherein the second camera is illuminated is its interior with a source of ultraviolet light, wherein the second camera contains in its interior a flow control mechanism, wherein the flow control mechanism gives origin to an exit that goes to an intake manifold;

Wherein the diaphragm that is between the first and the second camera is governed by the elastic mechanism of the first camera and the pressure of the second camera interior.

In an aspect of the device of the present invention, the flow control mechanism is a flow control lineal valve.

In another aspect of the device of the present invention, the source of ultraviolet light in the second camera is a LED (light emitting diode) that emits ultraviolet light.

In one aspect more of the device of the present invention, the liquid fuel is gasoline.

In another aspect of the device of the present invention, the elastic mechanism is a spring.

In one more aspect of the device of the present invention, the device has a third camera, wherein the second camera exit line goes throughout the third camera, wherein the second camera and the third camera are separated by a diaphragm, wherein the third camera has an axial expansion union surrounding the exit line, wherein the third camera has an exit orifice to the exterior of the device, wherein the second camera has an elastic mechanism joint to the diaphragm that is between the second and the third camera, wherein the diaphragm between the second and the third camera is governed by the elastic mechanism of the second camera and the expansion union of the third camera.

In another aspect of the device of the present invention, the second camera has an additional entry line, wherein said additional entry line is communicated with the recipient that contains the fuel.

In one additional aspect of the device of the present invention, the second camera has a volume of at least 40 cubic centimeters.

In a second version, the present invention provides a device to optimize combustion of fuel that is characterized by:
A. A first camera that contains an elastic mechanism, and an exit that goes to an intake manifold, and wherein the first camera is physically united to the camera describe in B., and wherein the union between the first camera and the camera described in B. is by means of a diaphragm;
B. A second camera with an entry of a liquid fuel line, wherein at the entry of the fuel line there is an atomizer, wherein the second camera contains in its interior a flow control mechanism, wherein the flow control mechanism gives origin to an exit that goes to an intake manifold;
C. A third camera, wherein the third camera is separated from the second camera by a diaphragm, wherein the third camera houses an ultrasonic transducer directly in contact with the diaphragm that is between the third camera and the second camera;

Wherein the diaphragm that is between the first and the second camera is governed by the elastic mechanism of the first camera, and the pressure of the second camera interior.

In one more aspect of the second version of the device of the present invention, the second camera is illuminated in its interior with a source of ultraviolet light. Preferably said source of ultraviolet light is an ultraviolet light emitting LED.

In one aspect of the second version of the device of the present invention, the liquid fuel is gasoline.

In another aspect of the second version of the device of the present invention, the flow control mechanism is a flow control lineal valve.

In one more aspect of the second version of the device of the present invention, the elastic mechanism is a spring.

In one additional aspect of the second version of the device of the present invention, the second camera has an additional entry line, wherein said additional entry line is communicated with the recipient that contains the fuel.

In another aspect of the second version of the device of the present invention, the second camera has a volume of at least 40 cubic centimeters.

In a third version, the present invention provides a device to optimize combustion of fuel that is characterized by:
A. A first camera that contains an elastic mechanism, and an exit that goes to an intake manifold, and wherein the first camera is physically united to the camera describe in B., and wherein the union between the first camera and the camera described in B. is by means of a diaphragm;
B. A second camera with a first entry of an air line, wherein at the air line entry there is a venturi mechanism, wherein the second camera has a second entry of a liquid fuel line, wherein said liquid fuel line continues inside the second camera until it joints the air line entry, wherein the second camera is illuminated in its interior with a source of ultraviolet light, wherein the second camera contains in its interior a flow control mechanism, wherein the flow control mechanism gives origin to an exit that goes to an intake manifold.

Wherein the diaphragm that is between the first and the second camera is governed by the elastic mechanism of the first camera, and the pressure of the second camera interior.

In another aspect of the third version of the device of the present invention, the flow control mechanism is a flow control lineal valve.

In one more aspect of the third version of the device of the present invention, the source of ultraviolet light in the second camera is an ultraviolet light emitting LED.

In another aspect of the third version of the device of the present invention, the liquid fuel is gasoline.

In another aspect of the third version of the device of the present invention, the elastic mechanism of the first camera is a spring.

In another aspect of the third version of the device of the present invention, the device has a third camera, wherein the exit line of the second camera goes throughout the third camera, wherein the second and third camera are separated by a diaphragm, wherein the third camera has an axial expansion union surrounding the exit line, wherein the third camera has an exit orifice to the exterior of the device, wherein the second camera has an elastic mechanism joint to the diaphragm that is between the second and the third camera, wherein the diaphragm between the second and the third camera is governed by the elastic mechanism of the second camera and the expansion union of the third camera.

In another aspect of the third version of the device of the present invention, the second camera has an additional entry line, wherein said additional entry line is communicated with the recipient that contains the fuel.

In a preferred aspect of the third version of the device of the present invention, the device has a third camera, wherein the third camera is separated from the second camera by a diaphragm, wherein the third camera houses an ultrasonic transducer directly in contact with the diaphragm that is between the third and the second camera.

In another aspect of the third version of the device of the present invention, the second camera has a volume of at least 40 cubic centimeters.

Objectives and additional advantages of the present invention will become more evident in the description of the figures, the detailed description of the invention and the claims.

### BRIEF DESCRIPTION OF THE DRAWINGS

FIG. 1. shows a sagittal cut of the preferred version of the device of the present invention.

FIG. 2. shows a sagittal cut of a variation of the preferred version of the device of the present invention.

FIG. 3. shows a sagittal cut of a second version of the device of the present invention.

FIG. 4. shows a sagittal cut of a third version of the device of the present invention.

FIG. 5. shows a sagittal cut of a variation of the third version of the device of the present invention.

FIG. 6. shows a sagittal cut of another variation of the third version of the device of the present invention.

### DETAILED DESCRIPTION OF THE INVENTION

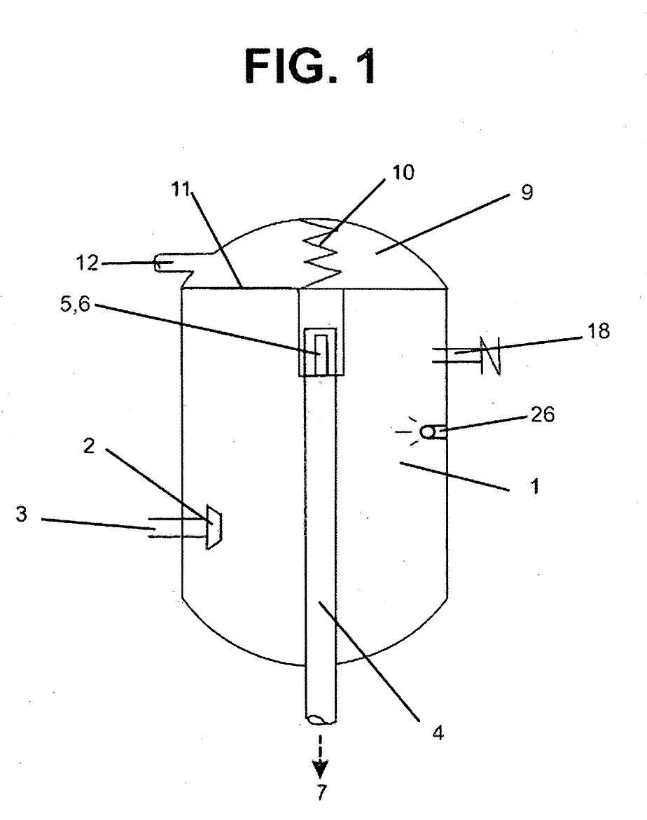

FIG. 1. Allows seeing technical aspects of the method of the present invention. FIG. 1. shows a closed camera (1) where a vacuum has been created, an atomizer (2) located at the end of the entry line (3) for a liquid fuel, an exit line (4) that allows the gasified fuel flow to leave toward the exterior of the closed camera (1), and a flow control mechanism (5) to regulate the leaving flow toward the exterior of the closed camera (1).

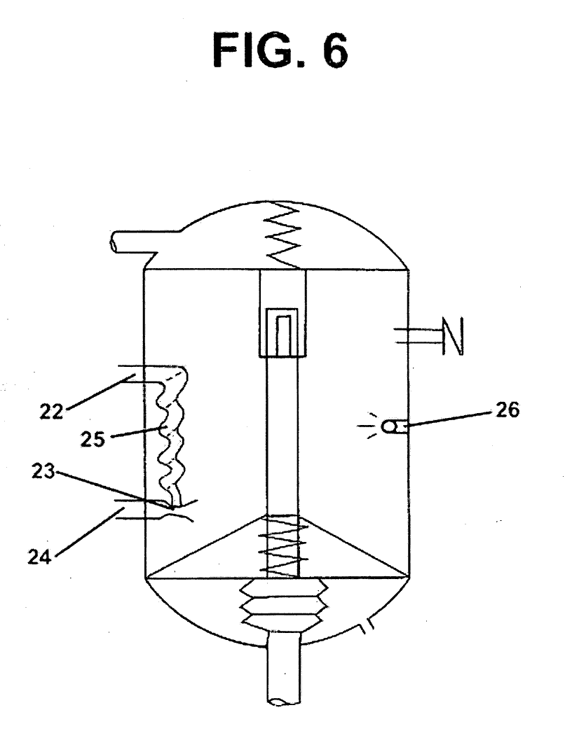

In a preferred aspect of all versions of the present invention the closed camera has a source of ultraviolet light that illuminates the interior of said closed camera (26) (FIGS. 1-6). Preferably said source is a LED (light emitting diode) (26) that emits ultraviolet light. However, the light source can be any light source that emits light with a wave length less than 500 nanometers (wave length range of ultraviolet light).

The purpose of the illumination with ultraviolet light is the production of oxygen radicals (production of superoxides and/or ozonization) derived from additives (ethanol, nitrates, etc.) or derived from air that are used to oxygenate fuels. For example, a LED of 3 watts (3 W) 365 nanometers wave length can be appropriate for a closed camera that has an internal space or volume of approximately 600 cubic centimeters. Since the fuel has been gasified, a LED can emit ultraviolet light of enough intensity to generate oxygen radicals. The effect of oxygen radicals generation can be more significant if the wave length of the ultraviolet light is lower, e.g., 250 nanometers or less.

In the preferred version of the method of the present invention, the flow control mechanism is a flow control lineal valve (6). The flow control mechanism can be any other kind of valve, or any other flow control mechanism, for example, a valve mechanism activated by a servomotor controlled by programming from “hardware”. For this application's purpose, hardware is defined as a computer, a module of logic control programming, etc., or any other device where a program can be implemented (software).

In another aspect of the method of the present invention, the vacuum inside the camera is created through an exit line (4) or through an additional line, wherein the exit line (4) or the additional line have a first end connected to the camera, and the second end connected to the vacuum source. In the case of the preferred version of FIG. 1. The vacuum source (7) is connected to the exit line second end (4).

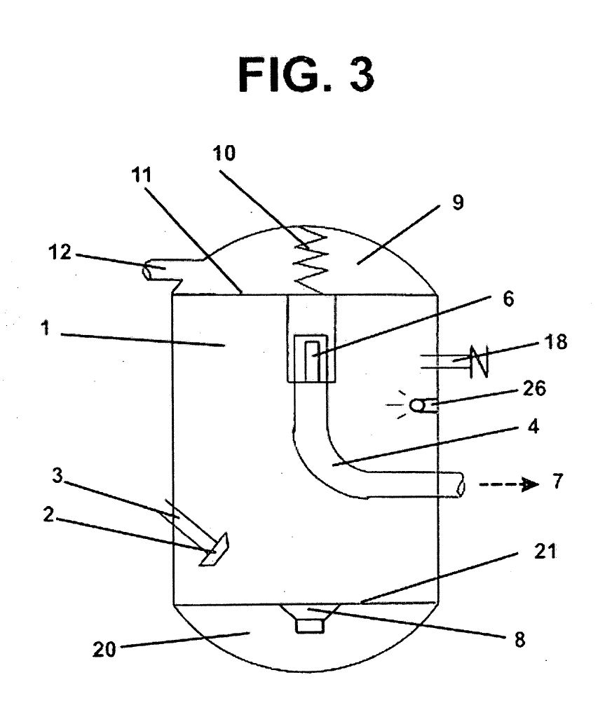

FIG. 3. shows another preferred version of the method of the present invention, wherein the closed camera (1) has an ultrasonic transducer (8), wherein said ultrasonic transducer breaks the molecular links that allow the fuel liquid state.

In an additional aspect of all versions of the device of the present invention, the second camera (1) has a volume of at least 40 cubic centimeters.

The present invention in a preferred version provides a device (FIGS. 1-6) to optimize combustion of fuel that is characterized by:
A. A first camera (9) that contains an elastic mechanism (10), and an exit (4) that goes to an intake manifold, and wherein the first camera (9) is physically united to the closed camera (1), and wherein the union between the first camera (9) and the closed camera (1) is by means of a diaphragm (11);
B. A second camera (closed camera) (1) with an entry line (3) of liquid fuel, wherein at the entry of the line (3) of fuel there is an atomizer (2), wherein the second camera is illuminated in its interior with a source of ultraviolet light (26), wherein the second camera (1) contains in its interior a flow control mechanism (5), wherein the flow control mechanism (5) gives origin to an exit (4) that goes to an intake manifold;

wherein the diaphragm (11) that is between the first (9) and the second camera (closed camera) (1) is governed by an elastic mechanism (10) that of the first camera (1), and the interior pressure of the second camera (1).

In the preferred version, the device of the present invention is used to gasify gasoline in an automobile or car, wherein the car has an engine with an intake manifold, and wherein the intake manifold is the vacuum source (7), and to where the gasified gasoline that leaves through the exit line (4) goes. In other versions of the present invention, the device can be used to gasify liquid fuels in burners, two stroke engines, and any other kind of machine that use liquid fuel.

When the device of the present invention is not applied to a car, the vacuum generating source can be any vacuum generator, for example, a turbine vacuum pump, or any other kind of vacuum pump. Depending on the vacuum generating source, the device of the present invention could need an additional line as it is mentioned in paragraph [00046].

In an aspect of the preferred versions of the device of the present invention, the flow control mechanism (5) is a flow control lineal valve (6). The flow control mechanism (5,6) allows the flow regulation of gasified gasoline toward the exit line (4), and in the case of the presented versions (FIGS. 1-6), said regulation is done through the diaphragm (11) that is between the first camera (9) and the second camera (1), wherein said diaphragm (11) is triggered by an elastic mechanism, wherein the elastic mechanism comprises, in the preferred version of the invention, resulting forces from the internal pressures of the first camera (9) and the second camera (1), and a spring (10) that is moved in accordance with the diaphragm movement (11). In the preferred version of the present invention, the first camera (9) has an internal pressure that tends toward vacuum since the first camera (9) has an exit (12) that is connected to the intake manifold, wherein the intake manifold acts as a vacuum source.

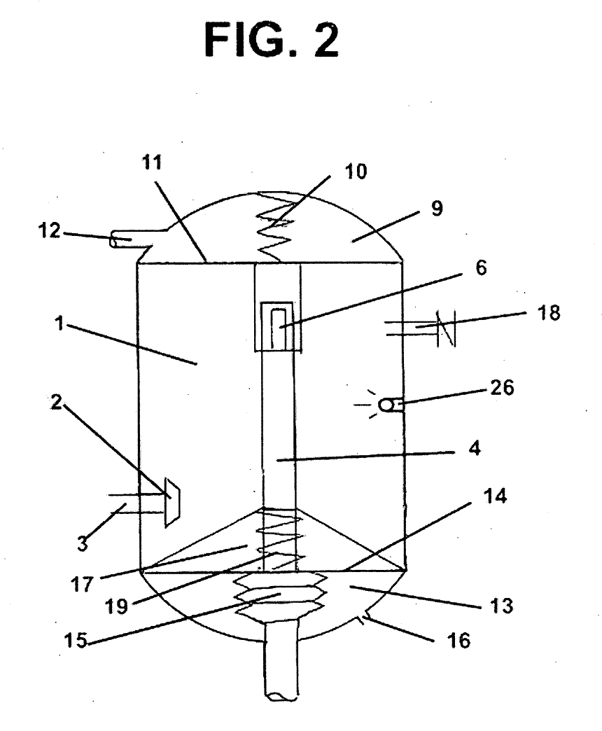

In one more aspect of the device of the device of the present invention, the device has a third camera (13) (FIGS. 2 y 6), wherein the exit line (4) of the second camera (1) goes throughout the third camera (13) (FIGS. 2 y 6), wherein the second (1) and the third camera (13) are separated by a diaphragm (14), wherein the third camera (13) has an axial expansion union (15) surrounding the exit line (4), wherein the third (13) has an exit orifice (16) toward the exterior of the device, wherein the second camera (1) has an elastic mechanism (17) united to the diaphragm (14) that is between the second camera (1) and the third camera (13), wherein the diaphragm (14) between the second (1) and the third camera (13) is governed by an elastic mechanism (17) of the second camera (1) and the expansion union (15) of the third camera (13). The diaphragm (14) between the second (1) and the third camera (13) is triggered by the elastic mechanism (17) of the second camera (1), wherein said elastic mechanism (17) comprises the resulting forces from the internal pressures of the second camera (1) and the pressure inside the third camera (13) [The pressure inside the third camera is equal to the atmospheric pressure due to the free communication with the exterior through the exit orifice (16)], that in two of the presented versions of the present invention (FIGS. 2 y 6), allow movement of said diaphragm (14) by means of a fixed spring (19), and the axial expansion union (15). In other words, the elastic mechanism (17) is equivalent to an altimeter.

In another aspect of the preferred versions of the device of the present invention, the second camera (1) has an additional entry line (18), wherein said additional entry line (18) is communicated with the recipient that contains the liquid fuel, and wherein the function of the additional entry line (18) is to collect gases that spontaneously are released from a recipient that contains liquid fuel. In the case of the preferred version of the invention, the recipient that contains liquid fuel is the car gasoline tank.

In an additional aspect of the second version of the present invention the device has a third camera (20) (FIGS. 3 y 4), wherein the third camera (20) is separated from the second camera by a diaphragm (21) (FIGS. 3 y 4), wherein the third camera (20) houses an ultrasonic transducer (8) directly in contact with the diaphragm (21) that is between the third camera (13) and the second camera (1). Preferably said diaphragm (21) is metallic.

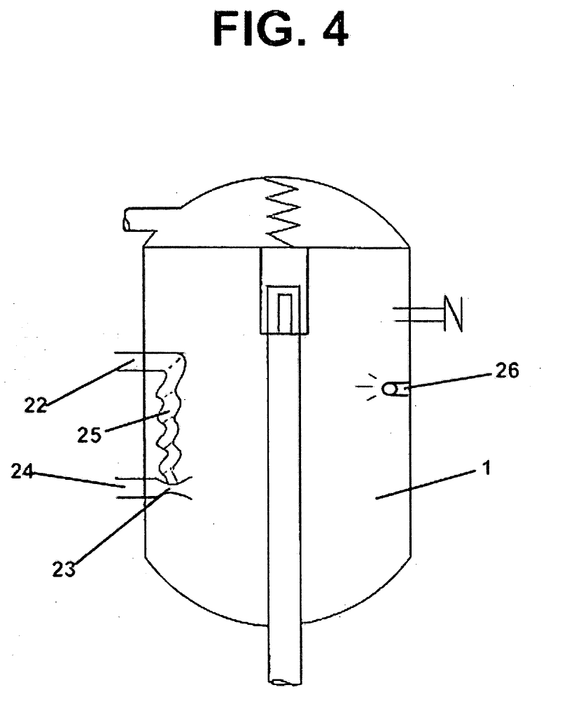

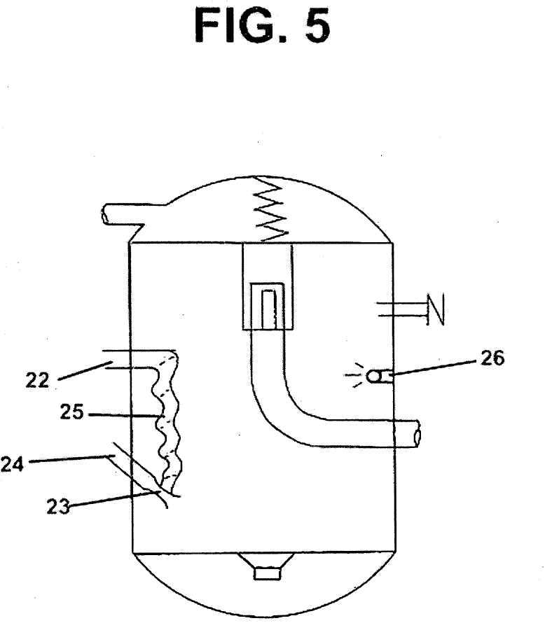

In another version (FIGS. 4, 5, y 6), the present invention provides a device to optimize the combustion of fuel that is further characterized by a second camera (1) with a first entry of an air line (22), where at the entry of the air line there is a venturi mechanism (23), wherein the second camera has a second entry of a line of liquid fuel (24), wherein said line of fuel continues inside the second camera until it connects to the air line entry (22). In this version of the device, the liquid fuel that enter into the second camera (1) is atomized by a venturi mechanism (23) with the help of air that enters in the air line (22), wherein the air line (22) ends in an spiral duct (25), this helps to twist the air that comes out into the liquid fuel entry line (24) in order to produce better atomization of the liquid fuel. In this version (FIGS. 4, 5, y 6) of the device of the present invention, although is not shown in the figures, the fuel exit line (4), in addition to being connected at one of its ends to a car intake manifold, it could be incorporated with a second vacuum generator source, for example, a turbine vacuum pump, or a vacuum pump mechanically activated by a car engine. Similarly the implementation of a second pump can be applied to the fuel exit line when is not the case of a car engine.

While the description presents the preferred embodiments of the present invention, additional changes can be made in the form and disposition of the parts without distancing from the basic ideas and principles comprised in the claims.

### Ejemplos

The device of the present invention (the device as it appears in FIG. 4. was used, except that the device used in these experiments did not have a source of ultraviolet light (26)) was installed in two kind of cars under different conditions as it is shown in the following tables. Results also appear in said tables. ECOPTY is the commercial name that tentatively has been given to the device.

PRIMER CARRO

| ENGINE SPECIFICATIONS | MITSUBISHI MONTERO |
|---|---|
| Model | 2.008 |
| Engyne Type | 3.8 L, 24 Valve SOHC V6 |
| Fuel Delivery | Sequential multi-port |
| | electronic fuel injection |
| Drive Type | Front wheel drive - 4 wheel |
| | drive |
| Transmission | 5 Speed Auto With Manual Mode |
| Engine Capacity | 3.800 cc |
| Horsepower | 215 HP |
| Torque | 245 lb - Feet |
| Fuel Capacity | 23, 24 Gallons |
| Weight | 4739 lb |

Mitsubishi - Dynamomenter Test Results
DYNAMOMETER TESTS

| | |
|---|---|
| ALTITUDE | 8.530 ft |
| TEST PLACE | BOGOTA |
| DATE | August 09/08 |
| TERRAIN | N/A |
| TEST TIME | 10:00:00 a.m.-4:00 p.m. |
| TEMPERATURE | 73.4° F. |
| HUMIDITY | 50% |
| WINDOWS | N/A |
| AIR CONDITIONER | OFF |
| TRANSMISSION | 4 × 4 |
| NUMBER OF PASSENGERS | 1 |
| PASSENGER WEIGHT | 154 Pounds |
| GASOLINE | 87 Octanes |
| WHEELS AIR PRESSURE | 30 PSI |
| TOTAL DRIVING DISTANCE | 46.66 Miles |
| AVERAGE SPEED | 49.7 mph |

| | Baseline | With COS | Fuel Savings |
|---|---|---|---|
| MILES PER GALLON | 18.22 | 22.752 | 24.873% |
| CONSUMPTION | 2.605 | 2.051 | 21.266% |
| (GALLONS) | | | |

Mitsubishi - 1^{ST}Road Test Results
TEST BASES

| | |
|---|---|
| ALTITUDE | 971 ft |
| PLACE | GIRARDOT-ESPINAL-GIRARDOT |
| TERRAIN | PLAIN-HIGHWAY |
| DATE | August 5th/08 |
| TEST TIME | 10:00:00 a.m.-12:00 p.m. |
| TEMPERATURE | 82° F. |
| HUMIDITY | 75% |
| WINDOWS | N/A |
| AIR CONDITIONER | OFF |
| TRANSMISSION | 4 × 2 |
| NUMBER OF PASSENGERS | 2 |
| PASSENGER WEIGHT | 330 Pounds |
| GASOLINE | 87 Octanes |
| WHEELS AIR PRESSURE | 30 PSI |
| TOTAL DRIVING DISTANCE | 85.7492 Miles |
| AVERAGE SPEED | 50 mph |

| | Baseline | With COS | Fuel Saving |
|---|---|---|---|
| MILES PER GALLON | 14.320 | 21.947 | 53.36% |
| CONSUMPTION | 5.992 | 3.907 | 34.79% |
| (Gallons) | | | |

MITSUBISHI - 2^{nd} ROAD TEST
ROAD TEST

| | |
|---|---|
| ALTITUDE | 8.530 Feet |
| TEST PLACE | Bogota-Gacheta-Chia-Cajica- |
| | Zipaquira-Nemocon-Bogota |
| TERRAIN | Plain |
| DATE | August 7th/08 |
| TEST TIME | |
| TEMPERATURE | 62.2° F. |
| HUMIDITY | |
| WINDOWS | N/A |
| AIR CONDITIONER | OFF |
| TRANSMISSION | 4 × 2 |
| PASSENGERS | 2 |
| PASSENGER WEIGHT | 330 Pounds |
| GASOLINE | 87 Octanes |
| WHEELS AIR PRESSURE | 30 PSI |
| TOTAL DRIVING DISTANCE | 88.98 Miles |
| AVERAGE SPEED | 62 MPH |

| | Baseline | With COS | Fuel Saving |
|---|---|---|---|
| MILES PER GALLON | 13.79 | 20.41 | 48.04% |
| CONSUMPTION | 6.452 | 4.358 | 32.45% |
| (Gallons) | | | |

MITSUBISHI - 3^{rd} ROAD TEST
ROAD TEST

| | |
|---|---|
| ALTITUDE | From 8.530 ft to 971 ft and Return |
| | from 971 ft to 8.530 ft |
| TEST PLACE | BOGOTA-GIRARDOT-BOGOTA |
| TERRAIN | Descending mountain and ascending |
| | mountain |
| DATE | August 5th/08 |
| TEST TIME | 3.00 PM-5:00 AM |
| TEMPERATURE | |
| HUMIDITY | |
| WINDOWS | N/A |
| AIR CONDITIONER | OFF |
| TRANSMISSION | 4 × 2 |
| PASSENGERS | 2 |
| PASSENGER WEIGHT | 330 Pounds |
| GASOLINE | 87 Octanes |
| WHEELS AIR PRESSURE | 30 PSI |
| TOTAL DRIVING DISTANCE | 135.45 Miles |
| AVERAGE SPEED | 49 MPH |

| | Baseline | With COS | Saving |
|---|---|---|---|
| MILES PER GALLON | 15.25 | 18.82 | 23.40% |
| CONSUMPTION | 9.11 | 7.926 | 12.99% |
| (Gallons) | | | |

SECOND CAR

| SPECIFICATIONS | ECOSPORT 2.0 L XLT 4WD |
|---|---|
| Model | 2007 |
| Engyne Type | Duratec 2.0 L DOHC 16 Valve |
| Fuel Delivery | Sequential multi-port electronic fuel |
| | injection |
| Drive Type | Front wheel drive - four wheel drive |
| Engine Capacity | 1.999 cc |
| Transmission | 5 Speed Manual |
| Horsepower | 138 HP @ 6000 RPM |
| Torque | 137 lb-ft @ 4500 RPM |
| Fuel Capacity | 13.21 Gallons |
| Weight | 3.031 lb |

Ford - Dynamometer Test Results
DYNAMOMETER TESTS

| ALTITUDE | | 8.530 ft | |
|---|---|---|---|
| TEST PLACE | | BOGOTA | |
| TERRAIN | | N/A | |
| DATE | | July 26Th/08 | |
| TEST TIME | | 10:00:00 a.m.-12:00 p.m. | |
| TEMPERATURE | | 68° F. | |
| HUMIDITY | | 58% | |
| WINDOWS | | N/A | |
| AIR CONDITIONER | | OFF | |
| TRANSMISSION | | 4 × 2 | |
| NUMBER OF PASSENGERS | | 1 | |
| PASSENGER WEIGHT | | 154 Pounds | |
| GASOLINE | | 87 Octanes | |
| WHEELS AIR PRESSURE | | 30 PSI | |
| TOTAL DRIVING DISTANCE | | 45.98Miles | |
| AVERAGE SPEED | | 45 mph | |
| | Baseline | With COS | Savings |
| Miles per Gallon | 43.22 | 56.92 | 31.69% |
| Consumption | 1.71 | 1.30 | 23.98% |
| (Gallons) | | | |

Ford - Road Test Results
ROAD TEST

| | |
|---|---|
| ALTITUDE | From 8.530 ft to 971 ft and Return |
| | from 971 ft to 8.530 ft |
| TEST PLACE | BOGOTA-GIRARDOT-BOGOTA |
| TERRAIN | Descending mountain and |
| | ascending mountain |
| DATE | July 27th/08 |
| TEST TIME | 10:00:00 a.m.-12:00 p.m. |
| TEMPERATURE | 64° F. |
| HUMIDITY | 75% |
| WINDOWS | N/A |
| AIR CONDITIONER | OFF |
| TRANSMISSION | 4 × 2 |
| NUMBER OF PASSENGERS | 2 |
| PASSENGER WEIGHT | 330 Pounds |
| GASOLINE | 87 Octanes |
| WHEELS AIR PRESSURE | 30 PSI |
| TOTAL DRIVING DISTANCE | 135.45 Miles |
| AVERAGE SPEED | 45 MPH |

| | Baseline | With COS | Savings |
|---|---|---|---|
| MILES PER GALLON | 28.672 | 37.60 | 31.1384% |
| CONSUMPTION (Gallons) | 4.97 | 4.47 | 10.09% |

The following table shows projected savings of approximately 25% in the two cars used if each one of the cars travels 15000 miles per year.

| | | COMSUMPTION | COMSUMPTION | | | |
|---|---|---|---|---|---|---|
| | | MILESS PER | MILESS PER | TON - | TON - | |
| | | GALLON | GALLON | MPG | MPG | SAVINGS |
| | DISTANCE | W/O ECOPTY | WITH ECOPTY | W/O | WITH | GALLONS PER |
| TEST | (Miles) | COMP | COMP | ECOPTY | ECOPTY | YEAR |
| Mitsubishi | 356.83 | 15.0524 | 20.4842 | 33.8528 | 46.0685 | 26.51% |
| Ford | 181.43 | 32.3003 | 42.4564 | 47.6106 | 62.5807 | 23.92% |
| Ecosport | | | | | | |

In an additional experiment, to the device exactly as it appears in the version of FIG. 4., it was added a ultraviolet light emitting LED (26) of 3 W with a wave length of 365 nanometers, wherein said device has an internal space of approximately 600 cubic centimeters. This device with an ultraviolet light emitting LED was installed to a third car, Chevrolet Vitara MY2007, Engine 2.5 Liters, 6 cylinders. With said device the Chevrolet Vitara yield results were approximately 67.8 miles per Gallon over a flat distance of 64.6 miles.

The same third car, Chevrolet Vitara, without the device, yield results were 37.49 miles per gallon, over a flat distance of 64.6 miles.

1. A method to gasify liquid fuel wherein said method comprises:
a. Creating a vacuum inside a closed camera;
b. Injecting to the inside of said camera a liquid fuel through an entry line that ends with an atomizer;
c. Illuminating the inside of said camera with ultraviolet light;
d. Allowing through an exit line a gasified fuel flow toward the exterior of the camera;
e. Regulating the gasified fuel flow that goes through the exit line toward the exterior of the closed camera by means of a flow control mechanism.

2. The method of claim 1, wherein the flow control mechanism is a flow control lineal valve.

3. The method of claim 1, wherein the camera is illuminated with a LED (light emitting diode) that emits ultraviolet light.

4. The method of claim 1, wherein the vacuum inside the camera is created through an additional line, wherein said additional line has a first end connected to the camera, and wherein the additional line has a second end connected to a vacuum source.

5. The method of claim 1, wherein the camera has an ultrasonic transducer, wherein said ultrasonic transducer breaks the molecular links that allow a liquid state.

6. The method of claim 1, wherein the closed camera has a volume of a least 40 cubic centimeters.

7. A device to optimize combustion of fuel wherein said device comprises:
a. A first camera that contains an elastic mechanism, and an exit that goes to an intake manifold, and wherein the first camera is physically united to the camera describe in B., and wherein the union between the first camera and the camera described in B. is by means of a diaphragm;
b. A second camera with an entry of a liquid fuel line, wherein at the entry of the fuel line there is an atomizer, wherein the second camera is illuminated is its interior with a source of ultraviolet light, wherein the second camera contains in its interior a flow control mechanism, wherein the flow control mechanism gives origin to an exit that goes to an intake manifold;
wherein the diaphragm that is between the first and the second camera is governed by the elastic mechanism of the first camera and the pressure of the second camera interior.

8. The device of claim 7, wherein the liquid fuel is gasoline.

9. The device of claim 7, wherein the flow control mechanism is a flow control lineal valve.

10. The device of claim 7, wherein the source of ultraviolet light in the second camera is a LED (light emitting diode) that emits ultraviolet light.

11. The device of claim 7, wherein the elastic mechanism is a spring.

12. The device of claim 7, wherein the device has a third camera, wherein the second camera exit line goes throughout the third camera, wherein the second camera and the third camera are separated by a diaphragm, wherein the third camera has an axial expansion union surrounding the exit line, wherein the third camera has an exit orifice to the exterior of the device, wherein the second camera has an elastic mechanism joint to the diaphragm that is between the second and the third camera, wherein the diaphragm between the second and the third camera is governed by the elastic mechanism of the second camera and the expansion union of the third camera.

13. The device of claim 7, wherein the second camera has an additional entry line, wherein said additional entry line is communicated with the recipient that contains the fuel.

14. The device of claim 7, wherein the second camera has a volume of at least 40 cubic centimeters.

15. A device to optimize combustion of fuel wherein said device comprises:
a. A first camera that contains an elastic mechanism, and an exit that goes to an intake manifold, and wherein the first camera is physically united to the camera describe in B., and wherein the union between the first camera and the camera described in B. is by means of a diaphragm;
b. A second camera with an entry of a liquid fuel line, wherein at the entry of the fuel line there is an atomizer, wherein the second camera contains in its interior a flow control mechanism, wherein the flow control mechanism gives origin to an exit that goes to an intake manifold;
c. A third camera, wherein the third camera is separated from the second camera by a diaphragm, wherein the third camera houses an ultrasonic transducer directly in contact with the diaphragm that is between the third camera and the second camera;
wherein the diaphragm that is between the first and the second camera is governed by the elastic mechanism of the first camera, and the pressure of the second camera interior.

16. The device of claim 15, wherein the second camera is illuminated in its interior with a source of ultraviolet light.

17. The device of claim 16, wherein the source of ultraviolet light is a LED (light emitting diode) that emits ultraviolet light.

18. The device of claim 15, wherein the liquid fuel is gasoline.

19. The device of claim 15, wherein the flow control mechanism is a flow control lineal valve.

20. The device of claim 15, wherein the elastic mechanism is a spring.

21. The device of claim 15, wherein the second camera has an additional entry line, wherein said additional entry line is communicated with the recipient that contains the fuel.

22. The device of claim 15, wherein the second camera has a volume of at least 40 cubic centimeters.

23. A device to optimize combustion of fuel wherein said device comprises:
a. A first camera that contains an elastic mechanism, and an exit that goes to an intake manifold, and wherein the first camera is physically united to the camera describe in B., and wherein the union between the first camera and the camera described in B. is by means of a diaphragm;
b. A second camera with a first entry of an air line, wherein at the air line entry there is a venturi mechanism, wherein the second camera has a second entry of a liquid fuel line, wherein said liquid fuel line continues inside the second camera until it joints the air line entry, wherein the second camera is illuminated in its interior with a source of ultraviolet light, wherein the second camera contains in its interior a flow control mechanism, wherein the flow control mechanism gives origin to an exit that goes to an intake manifold;
wherein the diaphragm that is between the first and the second camera is governed by the elastic mechanism of the first camera, and the pressure of the second camera interior.

24. The device of claim 23, wherein the liquid fuel is gasoline.

25. The device of claim 23, wherein the flow control mechanism is a flow control lineal valve.

26. The device of claim 23, wherein the source of ultraviolet light in the second camera is a LED (light emitting diode) that emits ultraviolet light.

27. The device of claim 23, wherein the elastic mechanism of the first camera is a spring.

28. The device of claim 23, wherein said device has a third camera, wherein the exit line of the second camera goes throughout the third camera, wherein the second and third camera are separated by a diaphragm, wherein the third camera has an axial expansion union surrounding the exit line, wherein the third camera has an exit orifice to the exterior of the device, wherein the second camera has an elastic mechanism joint to the diaphragm that is between the second and the third camera, wherein the diaphragm between the second and the third camera is governed by the elastic mechanism of the second camera and the expansion union of the third camera.

29. The device of claim 23, wherein the second camera has an additional entry line, wherein said additional entry line is communicated with the recipient that contains the fuel.

30. The device of claim 23, wherein said device has a third camera, wherein the third camera is separated from the second camera by a diaphragm, wherein the third camera houses an ultrasonic transducer directly in contact with the diaphragm that is between the third and the second camera.

31. The device of claim 23, wherein the second camera has a volume of at least 40 cubic centimeters.
